(19) United States
(12) Patent Application Publication
(10) Pub. No.: US 2009/0252476 A1
(43) Pub. Date: Oct. 8, 2009

(54) Television recorder, television receiver, and medium of storing control program

(75) Inventor: Yoji Kimura, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/457,516

(22) Filed: Jun. 12, 2009

Related U.S. Application Data
(63) Continuation of application No. PCT/JP2006/325091, filed on Dec. 15, 2006.

(51) Int. Cl. H04N 5/91; G06F 7/04

(52) U.S. Cl. 386/83; 340/5.83

(57) ABSTRACT

There are provided a TV recorder, a TV receiver, and a medium of storing a control program, which enable reliable recording of a TV program being broadcast in a channel used before switching while avoiding cumbersome operations. If information detected by an infrared camera indicates fluctuations in the number of TV viewers between before and after an instruction to change to a new display channel, a control section determines that the instruction to change to the new display channel is issued from a new TV viewer different from a TV viewer existing before the instruction is received, and makes a display signal output section output TV signals of the new display channel to a TV monitor and also makes a HDD record TV signals of the display channel used before the instruction to change to the new display channel is received.

### CROSS-REFERENCE TO RELATED APPLICATION

This is a continuation application of PCT/JP2006/325091, filed on Dec. 15, 2006.

### FIELD

The embodiments discussed herein are related to a television recorder that records television signals, a television receiver that outputs television signals to a recorder, and a medium of storing a control program that enables a device to be operated as at least one of the television recorder and television receiver.

### BACKGROUND

Conventionally, there are known a television (hereafter, “TV”) recorder equipped with a hard disk unit that records TV signals and a TV receiver that outputs TV signals top a recorder.

In a TV recorder, a TV receiver is attached thereto so that TV signals of a display channel among TV signals received by the TV receiver are output to the TV receiver and also TV signals of a recording channel among the TV signals are recorded in a hard disk unit included in the TV recorder.

In a TV receiver, a recorder is attached thereto so that an image based on TV signals of a display channel among TV signals received by the TV receiver is output to a TV monitor included in the TV receiver and also TV signals of a recording channel among the TV signals is output to the recorder.

In these TV recorder and TV receiver, a viewer can exercise various kinds of controls convenient to the viewer to watch TV programs. For example, the viewer can stop temporarily watching a program being broadcast in channel A to watch a program in channel B, and instead record the program being broadcast in the channel A in a hard disk unit (referred as “recording”), because the program in the channel A can not be watched while watching a program being broadcast in the channel B. However, in this case, the viewer needs to give an instruction to record the program being broadcast in the channel A, which-is a cumbersome operation.

Therefore, there is proposed a technique in which when a channel being watched by a viewer is switched from the channel A to channel B, TV signals of a program being broadcast in the channel A is recorded in a hard disk unit and when a channel being watched by the viewer is switched from the channel B to channel A, then the recorded TV signals are read from the hard disk unit to be reproduced (see Japanese Laid-open Patent Publication No. 2002-152652, for example). According to this technique, in order to switch from the channel A to channel B, the viewer does not need to give an instruction to record the program being broadcast in the channel A, thereby avoiding the cumbersome operation.

There is a situation in which while a father watches a live baseball game in a living room, his child enters into the living room and changes the channel to watch a drama. In such a case, a problem arises that the father cannot resume watching the baseball game from a point where the game is interrupted. If the technique proposed in Japanese Laid-open Patent Publication No. 2002-152652 is employed to address this problem, the following problem arises.

In the technique proposed in Japanese Laid-open Patent Publication No. 2002-152652, on switching a viewing channel from the channel A to channel B, although it is not necessary to give an instruction to record a program being broadcast in the channel A right on the spot, the viewer is required to execute an operation of presetting a display channel at the channel A so that the program being broadcast in the channel A can be recorded, or a condition that the program being broadcast in the channel A is being watched for a certain length of time is required. Because of this, if the viewer does not preset at the channel in which the live baseball game is broadcast, or the channel is switched to another channel immediately after the start of the live baseball game broadcast, the game cannot be recorded. Therefore, there is a problem in the above technique that if the viewing channel is switched, recording of the program being broadcast in the channel before switching fails.

### SUMMARY

According to an aspect of the invention, the TV recorder including:

a receiving section that receives TV signals;

a display signal output section that outputs TV signals of a display channel among the TV signals received by the receiving section, to a TV monitor equipped with a TV screen;

a recording section that records TV signals of a recording channel among the TV signals received by the receiving section; and

a control section that, upon receipt of an instruction of a display channel, makes the display signal output section output TV signals of the instructed display channel, and upon receipt of an instruction of a recording channel, makes the recording section record TV signals of the instructed recording channel,

wherein when the control section receives an instruction to change to a new display channel in the middle of outputting the TV signals of the display channel from the display signal output section, determines whether or not the instruction to change to the new display channel is issued by a new TV viewer different from a TV viewer existing before the instruction is received, and if it is determined that the instruction to change to the new display channel is issued from the new TV viewer different from the TV viewer existing before the instruction is received, the control section makes the display signal output section output TV signals of the new display channel and also makes the recording section record TV signals of the display channel used before the instruction to change to the new display channel is received.

If the TV recorder described above determines that an instruction to change to a new display channel is issued by a new TV viewer different from a TV viewer existing before the instruction is received, the TV recorder controls to output TV signals of the new display channel and also makes the recording section record TV signals of the display channel used before the instruction to change to the new display channel is received. Therefore, there is no need to execute an operation of presetting a viewing channel at the channel A so that a program being broadcast in the channel A can be recorded when the viewing channel is switched from the channel A to channel B. Also there is no need to keep watching the program being broadcast in the channel A for a certain length of time. The condition that the viewing channel is switched to the channel B is enough to record a program being broadcast in the channel A. In this way, the program being broadcast in the channel before switching can be readily recorded while avoiding the trouble of operations.

It is preferable that the TV recorder further includes a detecting section that detects information correlated with the number of TV viewers, and the control section determines that, if the information detected by the detecting section is information indicating increase or decrease in the number of TV viewers between before and after the instruction to change to the new display channel is received, the instruction to change to the new display channel is issued by a new TV viewer different from a TV viewer existing before the instruction is received.

For example, increase in the number of the TV viewers is detected in such a case where while a father watches a live baseball game in a living room, his child enters into the living room and changes the channel to watch a drama. By this, it is determined that the instruction to change to the new display channel is issued by a new TV viewer (in this case, child) different from the TV viewer existing (in this case, father) before the instruction is received. Consequently, the live baseball game the father has been watching can be recorded without executing any special operations.

It is also preferable that the detecting section in the TV recorder includes an infrared censor that detects information correlated with the number of TV viewers.

Using the infrared censor enables ready detection of information correlated with the number of TV viewers (such as the intensity of the infrared and the size of an area emitting the infrared).

It is also preferable that the TV recorder of the present invention further includes an authentication section that receives input operation of personal authentication information, and that the control section determines that, if the instruction to change to a new display channel is issued from a new person different from a person having been authenticated by the authentication section before the instruction is received, the instruction to change to the new display channel is issued from a new TV viewer different from a TV viewer existing before the instruction is received.

This enables accurate determination that the instruction to change to the new display channel is issued from a new TV viewer different from a TV viewer existing before the instruction is received.

It is also preferable that the TV recorder includes a remote controller by which an instruction of a TV viewer is input to the TV recorder, and the remote controller includes the authentication section therein.

This enhances operability, since the input operation of personal authentication information can be performed by the remote controller used to switch a viewing channel.

Also, it is preferable that the authentication section in the TV recorder of the present invention further includes a fingerprint sensor through which personal authentication information is entered.

In this case, personal authentication information can be surely entered.

Moreover, it is preferable that the control section in the TV recorder accepts input of an instruction of a display channel only for a predetermined length of time after the input of the personal authentication information is received by the authentication section.

In this case, after passing the predetermined length of time, input of an instruction of a display channel is not accepted unless personal authentication information is entered. That is, after passing the predetermined length of time, input of personal authentication information is ensured, thereby readily identifying a TV viewer who has entered the instruction to change a display channel. As a result, when input of an instruction of a display channel is received, accurate judgment can be made about whether or not recording of a program is executed.

Further, according to another aspect of the invention, the TV receiver including:

a receiving section that receives TV signals;

a TV monitor that outputs an image based on TV signals of a display channel among the TV signals received by the receiving section;

a recording signal output section that outputs therefrom TV signals of a recording channel among the TV signals received by the receiving section, to a recorder that records TV signals;

a control section that, upon receipt of an instruction of a display channel, makes the TV monitor output an image based on TV signals of the instructed display channel, and upon receipt of an instruction of a recording channel, makes the recording signal output section output therefrom TV signals of the instructed recording channel,

wherein when the control section receives an instruction to change to a new display channel in the middle of outputting the image based on the TV signals of the display channel from the TV monitor, determines whether or not the instruction to change to the new display channel is issued by a new TV viewer different from a TV viewer existing before the instruction is received, and if it is determined that the instruction to change to the new display channel is issued from the new TV viewer different from the TV viewer existing before the instruction is received, the control section makes the TV monitor output an image based on TV signals of the new display channel and also makes the recording signal output section output therefrom TV signals of the display channel used before the instruction to change to the new display channel is received.

If the TV receiver described above determines that an instruction to change to a new display channel is issued by a new TV viewer different from a TV viewer existing before the instruction is received, the TV receiver makes the TV monitor output an image based on TV signals of the new display channel and also makes the recording signal output section output TV signals of the display channel before the instruction to change to the new display channel is received. Therefore, there is no need to execute an operation of presetting a viewing channel at the channel A so that a program being broadcast in the channel A can be recorded when the viewing channel is switched from the channel A to channel B. Also there is no need to keep watching the program being broadcast in the channel A for a certain length of time. The condition that the viewing channel is switched to the channel B is enough to record the program being broadcast in the channel A. In this way, the program being broadcast in the channel before switching can be surely recorded while avoiding the trouble of operations.

Preferably, the TV receiver further includes a detecting section that detects information correlated with the number of TV viewers, and the control section determines that, if the information detected by the detecting section is information indicating increase or decrease in the number of TV viewers between before and after the instruction to change to the new display channel is received, the instruction to change to the new display channel is issued by a new TV viewer different from the TV viewer existing before the instruction is received.

In this case, increase in the number of the TV viewers is detected in such a case where while a father watches a live baseball game in a living room, his child enters into the living room and changes the channel to watch a drama. By this, it is determined that the instruction to change to the new display channel is issued by the new TV viewer different from the TV viewer before the instruction is received. Therefore, the live baseball game the father has been watching can be recorded without executing any special operations.

Preferably, the TV receiver further includes an authentication section that receives input operation of personal authentication information, and the control section determines that, if the instruction to change to a new display channel is issued from a new person different from a person having been authenticated by the authentication section before the instruction is received, the instruction to change to the new display channel is issued from a new TV viewer different from a TV viewer existing before the instruction is received.

This enables accurate determination that the instruction to change to the new display channel is issued from a new TV viewer different from a TV viewer before the instruction is received.

Further, according to yet another aspect of the invention, a first control program that is stored in the control program storage medium is executed in a TV recorder including a receiving section that receives TV signals; a display signal output section that outputs TV signals of a display channel among the TV signals received by the receiving section, to a TV monitor equipped with a TV screen; and a recording section that records TV signals of a recording channel among the TV signals received by the receiving section, and that makes the TV recorder being operated as a TV recorder that, upon receipt of an instruction of a display channel, makes the display signal output section output TV signals of the instructed display channel, and upon receipt of an instruction of a recording channel, makes the recording section record TV signals of the instructed recording channel, wherein the control program causes the TV recorder to determine, upon receipt of an instruction to change to a new display channel in the middle of outputting TV signals of the display channel from the display signal output section, whether or not the instruction to change to the new display channel is issued by a new TV viewer different from a TV viewer existing before the instruction is received, and if it is determined that the instruction to change to the new display channel is issued from the new TV viewer different from the TV viewer existing before the instruction is received, the TV recorder makes the display signal output section output TV signals of the new display channel and also makes the recording section record TV signals of the display channel used before the instruction to change to the new display channel is received.

Since the first control program described above enables operation of the TV recorder of the present invention, thereby a program being broadcast in a channel before switching can be surely recorded while avoiding the trouble of operations.

Moreover, according to still another aspect of the invention, a second control program that is stored in the control program storage medium is executed in a TV receiver including a receiving section that receives TV signals; a TV monitor that outputs an image based on TV signals of a display channel among the TV signals received by the receiving section; and a recording signal output section that outputs TV signals of a recording channel among the TV signals received by the receiving section, to a recorder that records TV signals, and that makes the TV receiver being operated as a TV receiver that, upon receipt of an instruction of a display channel, makes the TV monitor output an image based on TV signals of the instructed display channel, and upon receipt of an instruction of a recording channel, makes the recording signal output section output TV signals of the instructed recording channel, wherein the control program causes the TV receiver to determine, upon receipt of an instruction to change to a new display channel in the middle of outputting the TV signals of the display channel from the TV monitor, whether or not the instruction to change to the new display channel is issued by a new TV viewer different from a TV viewer existing before the instruction is received, and if it is determined that the instruction to change to the new display channel is issued from the new TV viewer different from the TV viewer existing before the instruction is received, the TV receiver makes the TV monitor output the image based on the TV signals of the new display channel and also makes the recording signal output section output TV signals of the display channel used before the instruction to change to the new display channel is received.

Since the second control program described above enables operation of the TV receiver, a program being broadcast in a channel before switching can be surely recorded while avoiding the trouble of operations.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a structure of a first embodiment of the TV recorder;

FIG. 2 is a block diagram of the TV recorder illustrated in FIG. 1;

FIG. 3 is a flowchart of a control routine for channel switching in a control program executed in the TV recorder illustrated in FIGS. 1 and 2;

FIG. 4 illustrates a structure of a second embodiment of the TV recorder;

FIG. 5 is a block diagram of the TV recorder illustrated in FIG. 4;

FIG. 6 is a flowchart of a control routine for channel switching in a control program executed in the TV recorder illustrated in FIGS. 4 and 5;

FIG. 7 illustrates a structure of a first embodiment of the TV receiver;

FIG. 8 is a block diagram of the TV receiver illustrated in FIG. 7;

FIG. 9 illustrates a structure of a second embodiment of the TV receiver; and

FIG. 10 is a block diagram of the TV receiver illustrated in FIG. 9.

### DESCRIPTION OF EMBODIMENTS

Embodiments of the present invention will be described below.

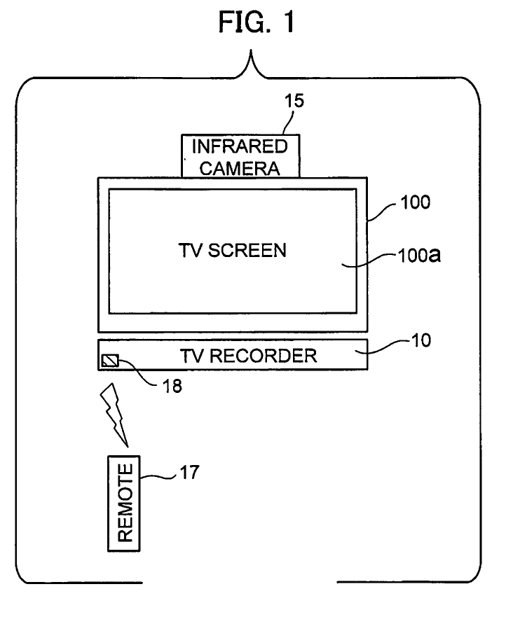

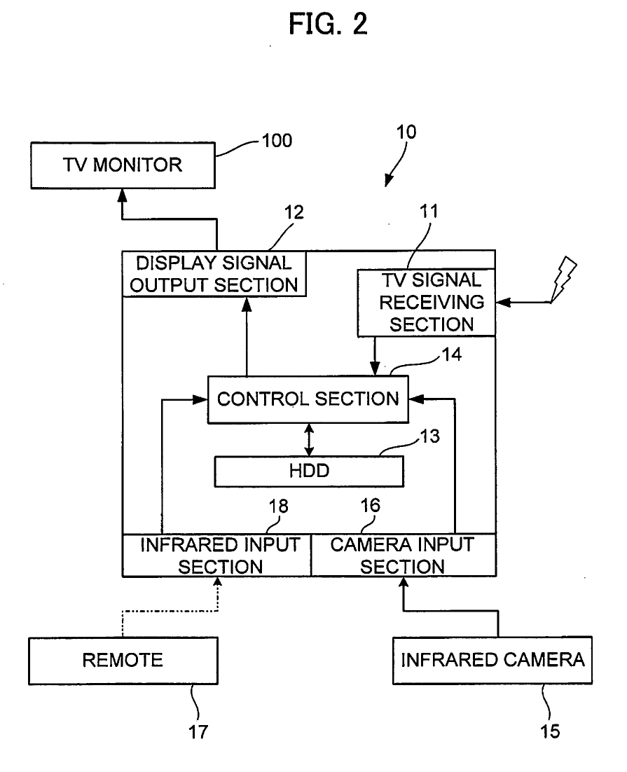

FIG. 1 illustrates a structure of a first embodiment of the TV recorder, and FIG. 2 is a block diagram of the TV recorder illustrated in FIG. 1.

FIG. 1 depicts a TV recorder 10 that is the first embodiment of the TV recorder and a TV monitor 100 equipped with a TV screen 100a.

The TV recorder 10 includes, as illustrated in FIG. 2, a TV signal receiving section 11 (corresponding to an example of the receiving section of the present invention) that receives TV signals.

The TV recorder 10 also includes a display signal output section 12 that outputs TV signals of a display channel among the TV signals received by the TV signal receiving section 11 to the TV monitor 100.

The TV recorder 10 further includes a hard disk unit (HDD) 13 (corresponding to an example of the recording section of the present invention) that records TV signals of a recording channel among the TV signals received by the TV signal receiving section 11.

Furthermore, the TV recorder 10 includes a control section 14 that, upon receipt of an instruction of a display channel, makes the display signal output section 12 output TV signals of the instructed display channel, and upon receipt of an instruction of a recording channel, makes the HDD 13 record TV signals of the instructed recording channel as well.

The control section 14 executes a control program to perform the following controls. That is, upon receipt of an instruction to change to a new display channel in the middle of outputting the TV signals of the display channel from the display signal output section 12, the control section 14 determines whether or not the instruction to change to the new display channel is issued by a new TV viewer different from a TV viewer before the instruction is received. Furthermore, if it is determined that the instruction to change to the new display channel is issued from the new TV viewer different from the TV viewer before the instruction is received, then the control section 14 makes the display signal output section 12 output TV signals of the new display channel and also makes the HDD 13 record TV signals of the display channel before the instruction to change to the new display channel is received.

The TV recorder 10 also includes an infrared camera 15 equipped with an infrared censor (corresponding to an example of the detecting section of the present invention) and a camera input section 16 into which signals from the infrared camera 15 are entered.

Here, the control section 14 determines that, if the information detected by the infrared camera 15 is information indicating increase or decrease in the number of TV viewers between before and after the instruction to change to the new display channel is received, the instruction to change to the new display channel is issued by a new TV viewer different from a TV viewer existing before the instruction is received.

The TV recorder 10 further includes a remote controller 17 (abbreviated as remote) by which an instruction of a TV viewer is input to the TV recorder 10 and an infrared input section 18 into which infrared signals are entered from the remote 17.

In the TV recorder 10 that is the first embodiment of the TV recorder, if the control section 14 determines that the instruction to change to the new display channel is issued by a new TV viewer different from a TV viewer before the instruction is received, the control section 14 controls to output TV signals of the new display channel and also makes the HDD 13 record TV signals of the display channel before the instruction to change to the new display channel is received. Therefore, there is no need to execute an operation of presetting a viewing channel at the channel A so that a program being broadcast in the channel A can be recorded when the viewing channel is switched from the channel A to channel B. Also there is no need to keep watching the program being broadcast in the channel A for a certain length of time. The condition that the viewing channel is switched to the channel B is enough to record the program being broadcast in the channel A. In this way, the program being broadcast in the channel before switching can be surely recorded while avoiding the trouble of operations.

In addition, since the TV recorder 10 is equipped with the infrared camera 15, for example, in such a case where while a father watches a live baseball game in the living room, if his child enters into the living room and changes the display channel, the infrared camera 15 detects increase in the size of an area where the infrared is emitted. In more detail, the infrared camera 15 measures the amount of infrared at each point in display angle by the infrared sensor, and recognizes an image by the infrared and thus detects increase in the size of the area where the infrared is emitted. By this, it is determined that the instruction to change to the new display channel is issued by a child who is a new TV viewer different from a father who is a TV viewer before the instruction is received. Therefore, without any special operation, the live baseball game the father is watching can be recorded.

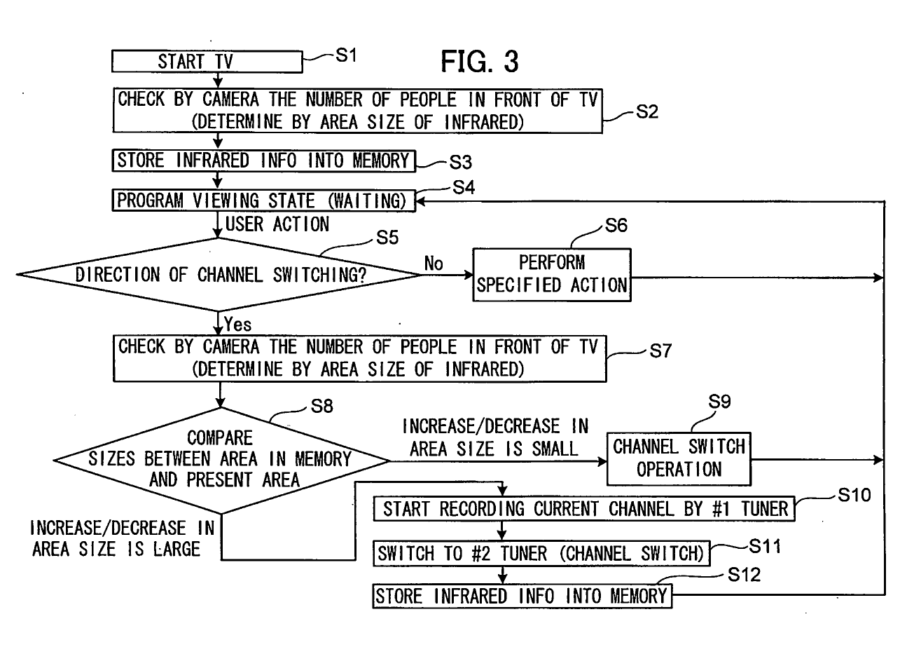

FIG. 3 is a flowchart of a control routine for channel switching in a control program executed in the TV recorder 10 illustrated in FIGS. 1 and 2.

Firstly, in step S1, the TV monitor 100 (abbreviated as TV) is started. Next, in step S2, the number of viewers in front of the TV is checked by the infrared camera 15 (abbreviated as camera). Specifically, the number of viewers in front of the TV is checked by the infrared sensor, based on information of increase or decrease in the size of an area concerning the number of viewers.

In step S3, the infrared information is stored into a memory included in the control section 14. Then, in step S4, the TV recorder is put into a TV program viewing state (standby state).

In this state, if a user action occurs, that is, if a viewer operates the remote 17, then in step S5, a judgment is made whether or not the action is an instruction of channel switching. If it is determined that the action is not the instruction of channel switching, the routine proceeds to step S6. Instep S6, the instructed action is performed and returns to step S4.

On the other hand, if it is determined that the action is the instruction of channel switching, the routine proceeds to step S7. In step S7, the number of viewers in front of the TV is checked by the camera (this checking is made based on the area size).

Next, in step S8, sizes are compared between the infrared information stored in the memory (“area in the memory”) and the information indicating the number of viewers in front of the TV (“present area”). If it is determined that increase or decrease in the area in the memory is small, that is, when it is determined that there is no increase or decrease in the number of viewers, the routine proceeds to step S9. In step S9, the action of channel switching is performed and returns to step S4.

On the other hand, if it is determined that increase or decrease in the area in the memory is large, that is, when it is determined that there is an increase/decrease in the number of viewers, the routine proceeds to step S10. In step S10, recording of the current channel starts by a first tuner. Next, in step S11, channel switching is performed by switching to a second tuner from the first tuner. Further, in step S12, the infrared information that indicates the present area is stored into the memory and returns to step S4.

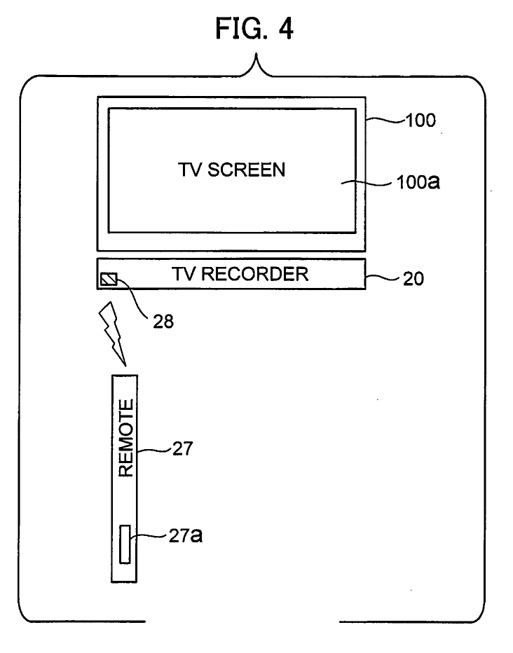

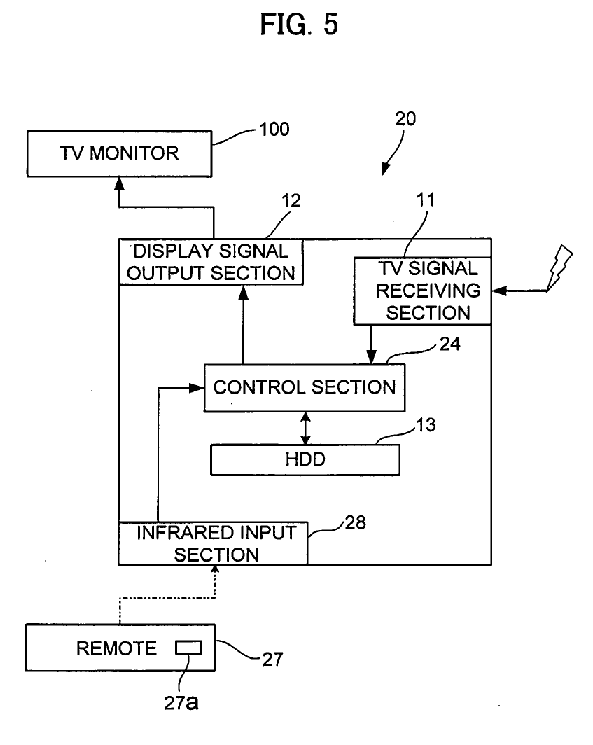

FIG. 4 illustrates a structure of a second embodiment of the TV recorder of the present invention, and FIG. 5 is a block diagram of the TV recorder illustrated in FIG. 4.

Hereafter, same numerals are added to elements that are same as those of the TV recorder 10 illustrated in FIGS. 1 and 2, and description is made about only different points.

As compared to the TV recorder 10, a TV recorder 20 illustrated in FIGS. 4, 5 is different in the points that the infrared camera 15 is removed and a remote 27 equipped with a fingerprint sensor 27a is included in place of the remote 17.

The TV recorder 20 includes the remote 27 by which an instruction of a TV viewer is entered into the TV recorder 20. The remote 27 is equipped with the fingerprint sensor 27a (corresponding to an example of the authentication section of the present invention) through which personal identification information is entered.

Further, a control section 24 included in the TV recorder 20 determines that, if the instruction to change to a new display channel is issued from a new person different from a person having been authenticated by the fingerprint sensor 27a before the instruction is received, the instruction to change to the new display channel is issued from the new TV viewer different from the TV viewer before the instruction is received.

Moreover, the control section 24 accepts input of an instruction of a display channel only for a predetermined length of time after the input of the personal authentication information is received by the fingerprint sensor 27a.

In the TV recorder 20 that is the second embodiment of the TV recorder of the present invention, a fingerprint pattern of a finger tip is read through the fingerprint sensor 27a, and access to the remote 27 is permitted when it is determined that the read fingerprint pattern and a fingerprint pattern that has been previously registered into the memory provided in the control section 24 match.

The fingerprint sensor 27a has a high operability since it is included in the remote 27 used for switching a viewing channel.

The control section 24 performs the following controls by executing the control program. That is, the control section 24 determines that, if the instruction to change to a new display channel is issued from a new person different from a person having been authenticated by the fingerprint sensor 27a before the instruction is received, the instruction to change to the new display channel is issued from a new TV viewer different from a TV viewer before the instruction is received. This enables accurate determination that the instruction to change to the new display channel is issued from the new TV viewer different from the TV viewer before the instruction is received.

In addition, the control section 24 accepts input of an instruction of a display channel only for a predetermined length of time after the input of the personal authentication information is received by the fingerprint sensor 27a. Because of this, after passing the predetermined time, input of an instruction of a display channel cannot be accepted unless personal identification information is entered. That is, after passing the predetermined time, input of the personal identification information is ensured. Therefore, in the TV recorder 20, it is possible to reliably know the TV viewer who has entered an instruction of a display channel. By this, it is possible to determine accurately whether or not the recording of a TV program is performed when the input of the instruction of a display channel is received.

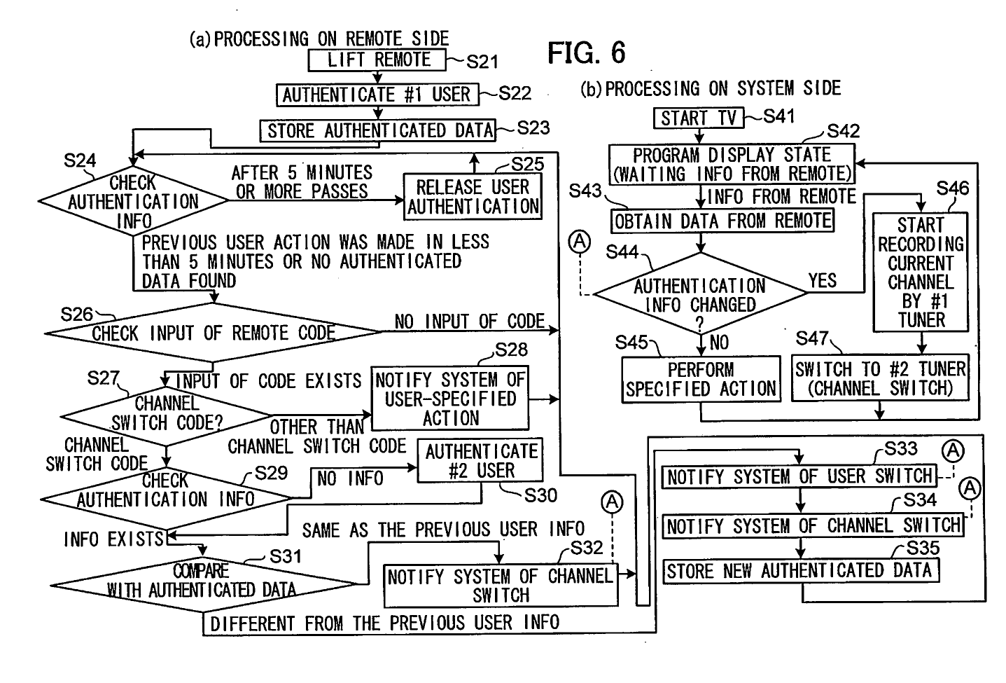

FIG. 6 is a flowchart of a control routine for channel switching in a control program executed in the TV recorder 20 illustrated in FIGS. 4 and 5.

As processing in the control routine, as illustrated in FIG. 6, there are processing on the remote 27 side and processing on the system (control section 24) side. First, processing on the remote 27 side is explained.

First, in step S21, the remote 27 is lifted. Next, in step S22, authentication of a first user (for example, a father) is performed. Further, instep S23, the authenticated data is stored into the memory included in the control section 24.

Next, in step S24, authentication information is checked. In this step, if it is determined that a user action is not performed previously for equal to or more than 5 minutes, the routine proceeds to step S25. In step S25, the user authentication is released and returns to step S24. On the other hand, if it is determined that a user action is performed previously in less than 5 minutes or if it is determined there is no authenticated data, the routine proceeds to step S26.

In step S26, input of a remote code is checked. If it is determined that there is no input of the remote code, the routine returns to step S24. On the other hand, if it is determined that the remote code is entered, the routine proceeds to step S27.

In step S27, it is determined whether or not the input is a channel switching code. If it is determined that the input is other than the channel switching code, the routine proceeds to step S28. In step S28, the action specified by the user is notified to the system and the routine returns to step S24. On the other hand, if it is determined that the input is the channel switching code, the routine proceeds to step S29.

In step S29, the authentication information is checked. If it is determined that there is no authentication information, the routine proceeds to step S30. In step S30, authentication of a second user (for example, a child) is performed and the routine proceeds to step S31. On the other hand, if it is determined that authentication information exists, the routine proceeds directly to step S31.

In step S31, a comparison is made between the stored authentication data and the present authentication data. As a result of the comparison, if it is determined that the present authentication data is the same as the previous authentication data (user information), the routine proceeds to step S32. In step S32, channel switching is notified to the system and the routine returns to step S24.

On the other hand, if it is determined that the present authentication data is different from the previous user information, the routine proceeds to step S33. In step S33, switching of a user is notified to the system and the routine proceeds to step S34. In step S34, channel switching is notified to the system and the routine returns to step S35. In step S35, the new authentication data is stored and the routine returns to step S24.

Next, processing on the system side will be explained.

First, in step S41, the TV is started. Next, in step S42, the TV is put into a TV program viewing state (standby state of waiting information from the remote). In this step, when the information is transmitted from the remote, then, in step S43, the information from the remote (data) is obtained.

Next, in step S44, a judgment is made whether or not there is change in the authentication information. The judgment is made by notification of the system executed in steps S32, 33, and 34. If it is determined that there is no change in the authentication information, the routine proceeds to step S45. In step S45, the specified action is executed and then the routine returns to step S42. On the other hand, if it is determined that there is change in the authentication information, the routine proceeds to step S46. In step S46, recording of the current channel by the first tuner starts. Next, in step S47, channel switching is performed by switching from the first tuner to the second tuner, and the routine returns to step S42.

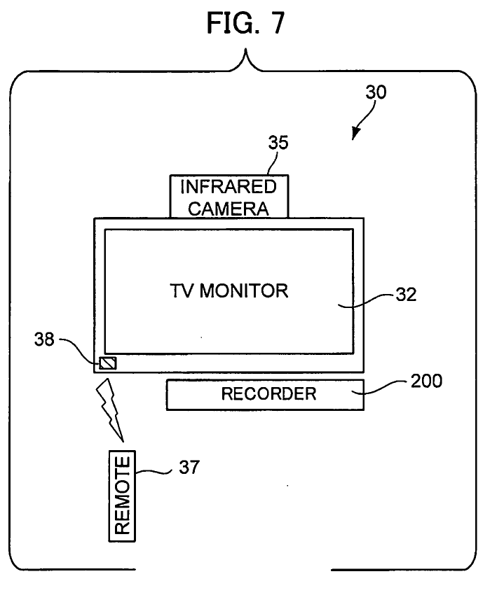

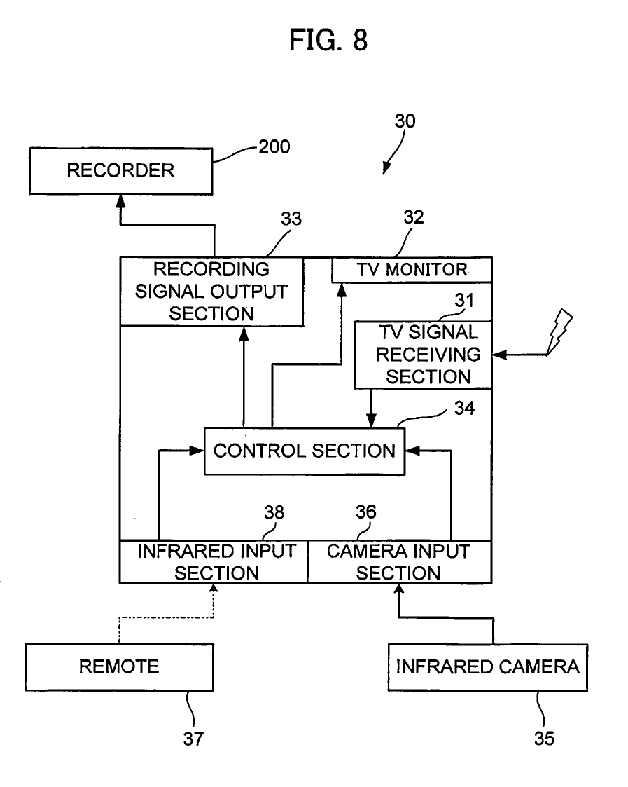

FIG. 7 illustrates a structure of a first embodiment of the TV receiver of the present invention, and FIG. 8 is a block diagram of the TV receiver illustrated in FIG. 7.

In FIG. 7, a TV receiver 30 that is the first embodiment of the TV receiver of the present invention and a recorder 200 are illustrated.

The TV receiver 30 includes a TV signal receiving section 31 that receives TV signals (corresponding to an example of the receiving section of the present invention), as illustrated in FIG. 8.

The TV receiver 30 also includes a TV monitor 32 (depicted in FIG. 7 as well) that outputs an image based on TV signals of a display channel among the TV signals received by the TV signal receiving section 31.

The TV receiver 30 also includes a recording signal output section 33 that outputs TV signals of a recording channel among the TV signals received by the TV signal receiving section 31 to the recorder 200 that records TV signals.

The TV receiver 30 further includes a control section 34 that, upon receipt of an instruction of a display channel, makes the TV monitor 32 output an image based on TV signals of the instructed display channel, and upon receipt of an instruction of a recording channel, makes the recording signal output section 33 output TV signals of the instructed recording channel as well.

The control section 34 performs the following controls by executing the control program. That is, the control section 34 determines, upon receipt of an instruction to change to a new display channel in the middle of outputting the TV signals of the display channel from the TV monitor 32, whether or not the instruction to change to the new display channel is issued by a new TV viewer different from a TV viewer before the instruction is received. If it is determined that the instruction to change to the new display channel is issued from the new TV viewer different from the TV viewer before the instruction is received, then control section 34 makes the TV monitor 32 output an image based on TV signals of the new display channel and also makes the recording signal output section 33 output TV signals of the display channel before the instruction to change to the new display channel is received.

The TV receiver 30 further includes an infrared camera 35 (corresponding to an example of the detecting section of the present invention) equipped with an infrared censor and a camera input section 36 into which signals from the infrared camera 35 are entered.

Here, the control section 34 determines that, if the information detected by the infrared camera 35 is information indicating increase or decrease in the number of TV viewers between before and after the instruction to change to the new display channel is received, the instruction to change to the new display channel is issued by a new TV viewer different from a TV viewer existing before the instruction is received.

The TV receiver 30 also includes a remote 37 by which an instruction of a TV viewer is entered to the TV receiver 30 and an infrared input section 38 into which infrared signals are entered from the remote 37.

In the TV receiver 30 that is the first embodiment of the TV receiver of the present invention, if the control section 34 determines that the instruction to change to the new display channel is issued from the new TV viewer different from the TV viewer before the instruction is received, then makes the TV monitor 32 output an image based on the TV signals of the new display channel and also makes the recording signal output section 33 output TV signals of the display channel before the instruction to change to the new display channel is received. Therefore, there is no need to execute an operation of presetting a viewing channel at the channel A so that a program being broadcast in the channel A can be recorded when the viewing channel is switched from the channel A to channel B. Also there is no need to keep watching the program being broadcast in the channel A for a certain length of time. The condition that the display channel is switched to the channel B is enough to record the program being broadcast in the channel A to the recorder 200. In this way, the program being broadcast in the channel before switching. can be surely recorded while avoiding the trouble of operations.

Moreover, since the TV receiver 30 is equipped with the infrared camera 35, for example, in such a case where while a father watches a live baseball game in the living room, if his child enters into the living room and changes a display channel, the infrared camera 35 detects that the size of an area where the infrared is emitted is increased. By this, it is determined that the instruction to change to the new display channel is issued by the child who is a new TV viewer different from the father who is a TV viewer before the instruction is received. Therefore, without any special operation, the live baseball game the father is watching can be recorded.

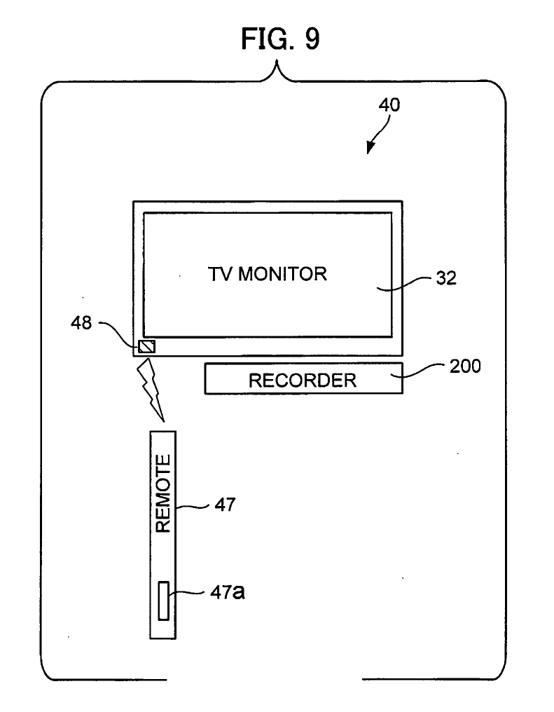

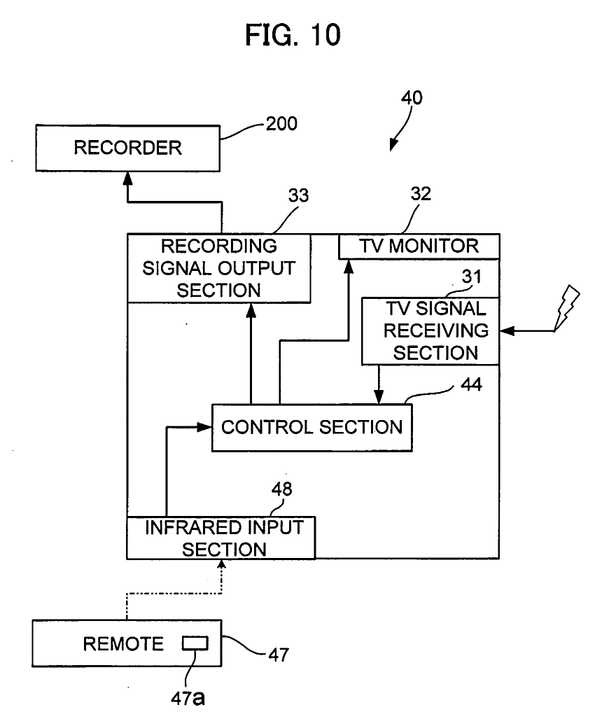

FIG. 9 illustrates a structure of a second embodiment of the TV receiver of the present invention, and FIG. 10 is a block diagram of the TV receiver illustrated in FIG. 9.

Hereafter, same marks are added to elements that are same as those of the TV receiver 30 illustrated in FIGS. 7 and 8, and description is made about only different points.

As compared to the TV receiver 30, a TV receiver 40 illustrated in FIGS. 9, 10 is different in the points that the infrared camera 35 is removed and a remote 47 equipped with a fingerprint sensor 47a is included in place of the remote 37.

The TV receiver 40 is equipped with the remote 47 by which an instruction of a TV viewer is entered to the TV receiver 40. This remote 47 is equipped with the fingerprint sensor 47a (corresponding to an example of the authentication section of the present invention) through which personal identification information is entered.

A control section 44 included in the TV receiver 40 performs the following controls by executing the control program. That is, the control section 44 determines that, if an instruction to change to a new display channel is issued by a new TV viewer different from a TV viewer who has been authenticated by the fingerprint sensor 47a before the instruction is received, the instruction to change to the new display channel is issued by the new TV viewer different from the TV viewer before the instruction is received.

In the TV receiver 40 that is the second embodiment of the TV receiver of the present invention, personal identification information can be entered by reading a fingerprint pattern of a finger tip by the fingerprint sensor 47a. Therefore, the personal identification information can be surely entered. Also the fingerprint sensor 47a has a high operability, since it is included in the remote 47 used for switching a viewing channel.

Further, the control section 44 determines that, if the instruction to change to a new display channel is issued from a new person different from a person having been authenticated by the fingerprint sensor 47a before the instruction is received, the instruction to change to the new display channel is issued from a new TV viewer different from a TV viewer before the instruction is received. This enables accurate determination that the instruction to change to the new display channel is issued from the new TV viewer different from the TV viewer before the instruction is received.

According to the present invention, it is possible to provide a TV recorder, a TV receiver, and a medium of storing a control program, which enable reliable recording of a program being broadcast in a channel before switching while avoiding the trouble of operations.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention has been described in detail, it should be understood that the various changes, substitutions, and alterations could be made hereto without departing from the spirit and scope of the invention.

What is claimed is:

1. A TV recorder, comprising:
a receiving section that receives TV signals;
a display signal output section that outputs TV signals of a display channel among the TV signals received by the receiving section, to a TV monitor equipped with a TV screen;
a recording section that records TV signals of a recording channel among the TV signals received by the receiving section; and
a control section that, upon receipt of an instruction of a display channel, makes the display signal output section output TV signals of the instructed display channel, and upon receipt of an instruction of a recording channel, makes the recording section record TV signals of the instructed recording channel,
wherein when the control section receives an instruction to change to a new display channel in the middle of outputting the TV signals of the display channel from the display signal output section, determines whether or not the instruction to change to the new display channel is issued by a new TV viewer different from a TV viewer existing before the instruction is received, and if it is determined that the instruction to change to the new display channel is issued from the new TV viewer different from the TV viewer existing before the instruction is received, the control section makes the display signal output section output TV signals of the new display channel and also makes the recording section record TV signals of the display channel used before the instruction to change to the new display channel is received.

2. The TV recorder according to claim 1, further comprising a detecting section that detects information correlated with the number of TV viewers, and
wherein the control section determines that, if the information detected by the detecting section is information indicating increase or decrease in the number of TV viewers between before and after the instruction to change to the new display channel is received, the instruction to change to the new display channel is issued by a new TV viewer different from a TV viewer existing before the instruction is received.

3. The TV recorder according to claim 2, wherein the detecting section further comprises an infrared censor that detects information correlated with the number of TV viewers.

4. The TV recorder according to claim 1, further comprising an authentication section that receives input operation of personal authentication information, and
wherein the control section determines that, if the instruction to change to a new display channel is issued from a new person different from a person having been authenticated by the authentication section before the instruction is received, the instruction to change to the new display channel is issued from a new TV viewer different from a TV viewer existing before the instruction is received.

5. The TV recorder according to claim 4, further comprising a remote controller by which an instruction of a TV viewer is input to the TV recorder, and the remote controller includes the authentication section therein.

6. The TV recorder according to claim 4, wherein the authentication section further comprises a fingerprint sensor through which personal authentication information is entered.

7. The TV recorder according to claim 5, wherein the authentication section further comprises a fingerprint sensor through which personal authentication information is entered.

8. The TV recorder according to claim 4, wherein the control section accepts input of an instruction of a display channel only for a predetermined length of time after the input of the personal authentication information is received by the authentication section.

9. The TV recorder according to claim 5, wherein the control section accepts input of an instruction of a display channel only for a predetermined length of time after the input of the personal authentication information is received by the authentication section.

10. A TV receiver, comprising:
a receiving section that receives TV signals;
a TV monitor that outputs an image based on TV signals of a display channel among the TV signals received by the receiving section;
a recording signal output section that outputs therefrom TV signals of a recording channel among the TV signals received by the receiving section, to a recorder that records TV signals;
a control section that, upon receipt of an instruction of a display channel, makes the TV monitor output an image based on TV signals of the instructed display channel, and upon receipt of an instruction of a recording channel, makes the recording signal output section output therefrom TV signals of the instructed recording channel,
wherein when the control section receives an instruction to change to a new display channel in the middle of outputting the image based on the TV signals of the display channel from the TV monitor, determines whether or not the instruction to change to the new display channel is issued by a new TV viewer different from a TV viewer existing before the instruction is received, and if it is determined that the instruction to change to the new display channel is issued from the new TV viewer different from the TV viewer existing before the instruction is received, the control section makes the TV monitor output an image based on TV signals of the new display channel and also makes the recording signal output section output therefrom TV signals of the display channel used before the instruction to change to the new display channel is received.

11. The TV receiver according to claim 10, further comprising a detecting section that detects information correlated with the number of TV viewers, and
wherein the control section determines that, if the information detected by the detecting section is information indicating increase or decrease in the number of TV viewers between before and after the instruction to change to the new display channel is received, the instruction to change to the new display channel is issued by a new TV viewer different from a TV viewer existing before the instruction is received.

12. The TV receiver according to claim 10, further comprising an authentication section that receives input operation of personal authentication information, and
wherein the control section determines that, if the instruction to change to a new display channel is issued from a new person different from a person having been authenticated by the authentication section before the instruction is received, the instruction to change to the new display channel is issued from a new TV viewer different from a TV viewer existing before the instruction is received.

13. A medium of storing a control program that is executed in a TV recorder comprising a receiving section that receives TV signals; a display signal output section that outputs TV signals of a display channel among the TV signals received by the receiving section, to a TV monitor equipped with a TV screen; and a recording section that records TV signals of a recording channel among the TV signals received by the receiving section, and that makes the TV recorder being operated as a TV recorder that, upon receipt of an instruction of a display channel, makes the display signal output section output TV signals of the instructed display channel, and upon receipt of an instruction of a recording channel, makes the recording section record TV signals of the instructed recording channel,
wherein the control program causes the TV recorder to determine, upon receipt of an instruction to change to a new display channel in the middle of outputting TV signals of the display channel from the display signal output section, whether or not the instruction to change to the new display channel is issued by a new TV viewer different from a TV viewer existing before the instruction is received, and if it is determined that the instruction to change to the new display channel is issued from the new TV viewer different from the TV viewer existing before the instruction is received, the TV recorder makes the display signal output section output TV signals of the new display channel and also makes the recording section record TV signals of the display channel used before the instruction to change to the new display channel is received.

14. A medium of storing a control program that is executed in a TV receiver comprising a receiving section that receives TV signals; a TV monitor that outputs an image based on TV signals of a display channel among the TV signals received by the receiving section; and a recording signal output section that outputs TV signals of a recording channel among the TV signals received by the receiving section, to a recorder that records TV signals, and that makes the TV receiver being operated as a TV receiver that, upon receipt of an instruction of a display channel, makes the TV monitor output an image based on TV signals of the instructed display channel, and upon receipt of an instruction of a recording channel, makes the recording signal output section output TV signals of the instructed recording channel,
wherein the control program causes the TV receiver to determine, upon receipt of an instruction to change to a new display channel in the middle of outputting the TV signals of the display channel from the TV monitor, whether or not the instruction to change to the new display channel is issued by a new TV viewer different from a TV viewer existing before the instruction is received, and if it is determined that the instruction to change to the new display channel is issued from the new TV viewer different from the TV viewer existing before the instruction is received, the TV receiver makes the TV monitor output the image based on the TV signals of the new display channel and also makes the recording signal output section output TV signals of the display channel used before the instruction to change to the new display channel is received.
